(19) United States
(12) Patent Application Publication
(10) Pub. No.: US 2011/0102725 A1
(43) Pub. Date: May 5, 2011

(54) LIQUID CRYSTAL DISPLAY DEVICE

(76) Inventors: Kazunari Katsumoto, Osaka (JP); Yasutoshi Tasaka, Osaka (JP)

(21) Appl. No.: 13/001,304

(22) PCT Filed: Jun. 17, 2009
(86) PCT No.: PCT/JP2009/002766

§ 371 Date: Dec. 23, 2010

(30) Foreign Application Priority Data
Jun. 24, 2008 (JP) 2008-164983

(51) Int. Cl. G02F 1/1343

(52) U.S. Cl. 349/143

(57) ABSTRACT

A liquid crystal display device according to the present invention includes: an active-matrix substrate including a pixel electrode, a gate line (G), and a source line (S); a counter substrate including a counter electrode; and a liquid crystal layer. The active-matrix substrate further includes a conductive layer, which is arranged in an insulating layer between the gate line (G) and the pixel electrode. The conductive layer has a portion that is located between the first and second regions of the pixel electrode. And the conductive layer is electrically connected to either the pixel electrode or the source line (S).

### TECHNICAL FIELD

The present invention relates to a liquid crystal display device.

### BACKGROUND ART

Liquid crystal displays (LCDs) have been used in not only TV sets with a big screen but also small display devices such as the monitor screen of a cellphone. TN (twisted nematic) mode LCDs, which would often be used in the past, achieved so narrow viewing angles that LCDs of various other modes with wider viewing angles have been developed one after another. Examples of those wider viewing angle modes include IPS (in-plane switching) mode and VA (vertical alignment) mode. Among those wide viewing angle modes, the VA mode is adopted in a lot of LCDs because the VA mode would achieve a sufficiently high contrast ratio.

Known as a kind of VA mode LCD is an MVA (multi-domain vertical alignment) mode LCD in which multiple liquid crystal domains are defined within a single pixel region (see Patent Documents Nos. 1 and 2, for example). In an MVA mode LCD, an alignment regulating structure is arranged on at least one of its two substrates, which face each other with a vertical alignment liquid crystal layer interposed between them, so that the alignment regulating structure faces the liquid crystal layer. As the alignment regulating structure, a linear slit (opening) or a rib (projection) of an electrode may be used, thereby applying alignment regulating force to the liquid crystal layer from one or both sides thereof. In this manner, multiple (typically four) liquid crystal domains with multiple different alignment directions are defined, thereby attempting to improve the viewing angle characteristic.

Also known as another kind of VA mode LCD is a CPA (continuous pinwheel alignment) mode LCD (see Patent Document No. 3, for example). In a CPA mode LCD, one of two electrodes that face each other with a liquid crystal layer interposed between them has an aperture or a notch cut through itself, thereby generating an oblique electric field over the aperture or notch and inducing radially tilting alignments of liquid crystal molecules. As a result, a wide viewing angle is realized. Furthermore, in the CPA mode LCD, an alignment regulating structure (such as a rivet or an opening) may be further provided for the other substrate, which is opposed to the substrate on which such an electrode with the aperture or notch is arranged, thereby stabilizing the radially tilting alignments of the liquid crystal molecules.

In the CPA mode LCD, however, if a pixel region had a low degree of symmetry, the radially tilting alignments of liquid crystal molecules sometimes could not be stabilized. In that case, a technique for splitting a pixel into a number of highly symmetric regions and stabilizing the radially tilting alignments of liquid crystal molecules in each of those regions could be used (see Patent Document No. 4, for example).

FIG. 9 is a schematic representation illustrating a liquid crystal display device 900 as disclosed in Patent Document No. 4. The liquid crystal display device 900 includes a gate line G for supplying a gate signal to select a TFT 924, a source line S for supplying a data signal to a pixel electrode 922, and a storage capacitor line CS to store the electric charge of the pixel electrode 922. The gate and storage capacitor lines G and CS run parallel to each other, while the source line S intersects with these lines. Although not shown in FIG. 9, a black matrix is provided for the counter substrate to shield the gate line G, source line S and storage capacitor line CS.

In the liquid crystal display device 900, the pixel electrode 922 is split into two regions 922a and 922b, for which the counter substrate provides two rivets 942a and 942b, respectively. Also, in this liquid crystal display device 900, the gate line G runs between two vertical pixels, which are adjacent to each other in the column direction, and the storage capacitor line CS runs between those two regions 922a and 922b of the pixel electrode 922. By splitting each pixel into two in this manner, radially tilting alignments of liquid crystal molecules can be stabilized.

### CITATION LIST

### Patent Literature

Patent Document No. 1: Japanese Patent Application Laid-Open Publication No. 2006-11400
Patent Document No. 2: Japanese Patent Application Laid-Open Publication No. 2007-256908
Patent Document No. 3: Japanese Patent Application Laid-Open Publication No. 2003-228073
Patent Document No. 4: Japanese Patent Application Laid-Open Publication No. 2007-316234

### SUMMARY OF INVENTION

### Technical Problem

Generally speaking, a storage capacitor line is wider than a gate line because the wider the storage capacitor line, the more efficiently a potential at a pixel electrode can be held. In the liquid crystal display device 900, however, such a wide storage capacitor line CS runs across the center of the pixel region, and therefore, the pixel region cannot be used so effectively as to achieve a sufficiently high aperture ratio. Nevertheless, even if the positions of these two lines are simply changed with each other so that the relatively narrow gate line runs across the center of the pixel region and that the storage capacitor line runs between two vertical pixels that are adjacent to each other in the column direction, then the alignments of liquid crystal molecules could be disturbed significantly by the gate line, which could produce a potential of relatively great amplitude.

It is therefore an object of the present invention to provide a liquid crystal display device that can minimize not only such a decrease in aperture ratio but also disturbed alignment of liquid crystal molecules as well.

### Solution to Problem

A liquid crystal display device according to the present invention includes: an active-matrix substrate including a pixel electrode, a gate line, and a source line; a counter substrate including a counter electrode; and a liquid crystal layer, which is interposed between the pixel electrode and the counter electrode. As viewed along a normal to the principal surface of the active-matrix substrate, the pixel electrode has first and second regions, which are respectively arranged on one and the other sides with respect to the gate line. The active-matrix substrate further includes a conductive layer, which is arranged in an insulating layer between the gate line and the pixel electrode. As viewed along a normal to the principal surface of the active-matrix substrate, the conductive layer has a portion that is located between the first and second regions of the pixel electrode, does overlap the gate line, but is not overlapped by the pixel electrode. And the conductive layer is electrically connected to either the pixel electrode or the source line.

In one embodiment, the conductive layer and the source line are made of the same material.

In one embodiment, the active-matrix substrate further includes: a semiconductor layer; a thin-film transistor having the source, channel and drain regions defined in the semiconductor layer; and a drain electrode, which is electrically connected to the drain region of the thin-film transistor and to the pixel electrode.

In one embodiment, the drain electrode and the source line are made of the same material.

In one embodiment, the conductive layer is connected to the source line.

In one embodiment, the conductive layer is electrically connected to the pixel electrode.

In one embodiment, the conductive layer is connected to the drain electrode.

In one embodiment, the pixel electrode further has a connection region that connects the first and second regions together.

In one embodiment, the first and second regions of the pixel electrode define first and second subpixel electrodes, respectively.

In one embodiment, the active-matrix substrate further includes a storage capacitor line.

Another liquid crystal display device according to the present invention includes: an active-matrix substrate including a pixel electrode, a gate line, a source line and a storage capacitor line; a counter substrate including a counter electrode; and a liquid crystal layer, which is interposed between the pixel electrode and the counter electrode. As viewed along a normal to the principal surface of the active-matrix substrate, the pixel electrode has first and second regions, which are respectively arranged on one and the other sides with respect to the gate line. The active-matrix substrate further includes a conductive layer, which is arranged in an insulating layer between the gate line and the pixel electrode. As viewed along a normal to the principal surface of the active-matrix substrate, the conductive layer has a portion that is located between the first and second regions of the pixel electrode, does overlap the gate line, but is not overlapped by the pixel electrode. The conductive layer is electrically connected to the pixel electrode, the source line or the storage capacitor line.

In one embodiment, a potential on the storage capacitor line varies in the same phase with a potential at the counter electrode, and the conductive layer is electrically connected to the storage capacitor line.

### Advantageous Effects of Invention

The present invention provides a liquid crystal display device that can minimize both a decrease in aperture ratio and disturbed alignment of liquid crystal molecules.

### BRIEF DESCRIPTION OF DRAWINGS

FIG. 1(a) is a schematic plan view illustrating a liquid crystal display device as a embodiment according to the present invention, and FIGS. 1(b) and 1(c) are schematic cross-sectional views thereof.

FIG. 2 is a schematic plan view illustrating a liquid crystal display device as Comparative Example 1.

Portions (a) through (j) of FIG. 3 are schematic representations illustrating equipotential curves to be traced in the liquid crystal display device of Comparative Example 1.

FIGS. 4(a) and 4(b) are respectively a schematic plan view and a cross-sectional view illustrating a liquid crystal display device as Comparative Example 2.

Portions (a) through (h) of FIG. 5 are schematic representations illustrating equipotential curves to be traced in the liquid crystal display device shown in FIG. 1.

FIGS. 6(a) to 6(c) are schematic representations illustrating equipotential curves to be traced in the liquid crystal display device shown in FIG. 1.

FIGS. 7(a) to 7(c) are schematic representations illustrating equipotential curves to be traced in the liquid crystal display device shown in FIG. 1.

FIGS. 8(a) and 8(b) are respectively a schematic plan view and a schematic cross-sectional view illustrating a liquid crystal display device as another embodiment according to the present invention.

FIG. 9 is a schematic plan view illustrating conventional liquid crystal display device.

### DESCRIPTION OF EMBODIMENTS

Hereinafter, embodiments of a liquid crystal display device according to the present invention will be described with reference to the accompanying drawings. However, the present invention is in no way limited to those specific embodiments to be described below.

### Embodiment 1

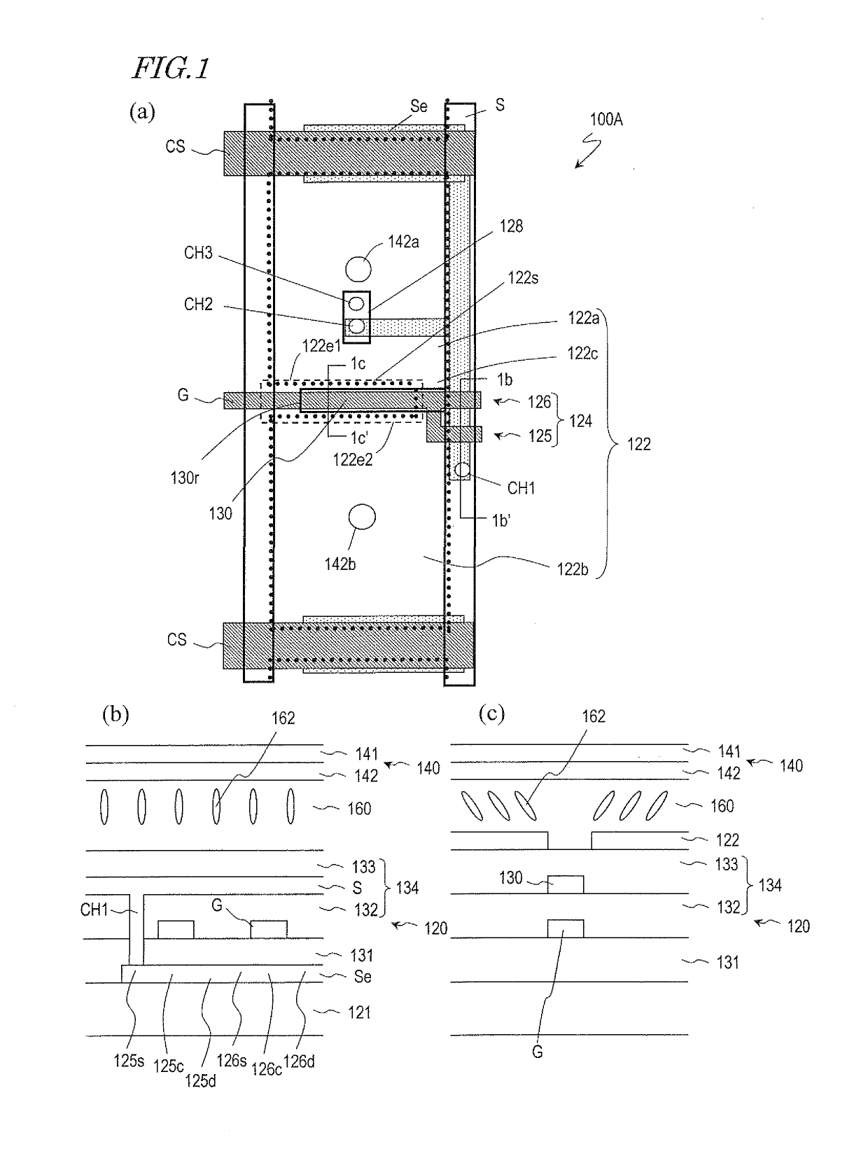

A first embodiment of a liquid crystal display device according to the present invention will now be described with reference to FIG. 1.

Specifically, FIG. 1(a) is a schematic plan view illustrating a liquid crystal display device 100A as a first specific embodiment of the present invention, and FIGS. 1(b) and 1(c) are schematic cross-sectional views of the liquid crystal display device 100A as viewed on the respective planes 1b-1b′ and 1c-1c′ shown in FIG. 1(a).

The liquid crystal display device 100A includes an active-matrix substrate 120, a counter substrate 140 and a liquid crystal layer 160 that is interposed between the active-matrix substrate 120 and the counter substrate 140. The active-matrix substrate 120 includes a transparent substrate 121, gate lines G, source lines S, storage capacitor lines CS, a semiconductor layer Se, pixel electrodes 122, switching elements 124, and drain electrodes 128. The gate lines G run parallel to the storage capacitor lines CS. The source lines S intersect with the gate lines G and the storage capacitor lines CS. On the other hand, the counter substrate 140 includes a transparent substrate 141 and a counter electrode 142.

In this liquid crystal display device 100A, a number of pixels are arranged in columns and rows to form a matrix pattern. Each of those pixels is defined by its associated pixel electrode 122. As used herein, the “pixel” refers to a minimum unit of display that represents a particular grayscale. In a color display, each pixel is a unit that represents the grayscale of R, G or B and is also called a “dot”. And a combination of R, G and B pixels forms a single color display pixel.

Also, in this embodiment, each switching element 124 includes two thin-film transistors (TFTs) 125 and 126, which are connected in series together and both of which have a top gate structure. By arranging multiple TFTs side by side in this manner, the amount of OFF-state current to flow through the switching element 124 can be reduced. Optionally, only one TFT may be used as each switching element 124.

The semiconductor layer Se includes polysilicon. The source, channel and drain regions 125s, 125c and 125d of the TFT 125 and those 126s, 126c and 126d of the TFT 126 are all defined in the semiconductor layer Se. Among these regions, the channel regions 125c and 126c form parts of the semiconductor layer Se that are overlapped by the gate line G. And portions of the gate line G that overlap the channel regions 125c and 126c function as gate electrodes for the TFTs 125 and 126, respectively. The semiconductor layer Se also has a storage capacitor region, which is capacitively coupled to the storage capacitor lines CS and which is connected to the drain region 126d.

The source region 125s of the semiconductor layer Se is electrically connected to the source line S by way of a contact hole CH1 that has been cut through an insulating layer 132. The drain region 125d of the TFT 125 is continuous with the source region 126s of the TFT 126. Likewise, the drain region 126d is electrically connected to the drain electrode 128 by way of another contact hole CH2 that has been cut through the insulating layer 132. And the drain electrode 128 is electrically connected to the pixel electrode 122 by way of a third contact hole CH3 that has been cut through another insulating layer 133. That is why the potential at the pixel electrode 122 is equal to the potential at the drain electrode 128.

The pixel electrode 122 is made of a transparent conductor such as indium tin oxide (ITO). The pixel electrode 122 may have a width of 40 μm as measured in the x direction and a length of 120 μm as measured in the y direction. That is why the pixel region defined by the entire pixel electrode 122 has a relative large aspect ratio. However, the pixel electrode 122 does have the first and second regions 122a and 122b that have a relatively small aspect ratio and a highly symmetric shape. For example, the first and second regions 122a and 122b may have a rectangular shape. And as viewed along a normal to the principal surface of the active-matrix substrate 20, the first region 122a is located on one side of the gate line G and the second region 122b is located on the other side of the gate line G.

The first region 122a is directly connected to the second region 122b through a connection region 122c. A slit 122s has been cut through the pixel electrode 122 between the first and second regions 122a and 122b thereof. And the slit 122s of the pixel electrode 122 is arranged to correspond to the gate line G. As viewed along a normal to the principal surface of the active-matrix substrate 120, the edges 122e1 and 122e2 of the first and second regions 122a and 122b face each other. Thus, the pixel electrode 122 has a U-shape.

On the other hand, on the surface of the counter substrate 140 that faces the liquid crystal layer 160, alignment regulating structures 142a and 142b are arranged so as to face approximately the respective center portions of the first and second regions 122a and 122b of the pixel electrode 122. In this embodiment, either rivets or openings may be used as the alignment regulating structures 142a and 142b. The counter electrode 142 may also be made of ITO.

The liquid crystal layer 160 is a vertical alignment type and may include a nematic liquid crystal material with negative dielectric anisotropy. Although not shown in FIG. 1, each of the active-matrix substrate 120 and the counter substrate 140 has an alignment layer. And in black display state, the liquid crystal molecules 162 in the liquid crystal layer 160 are aligned substantially perpendicularly to the principal surface of the alignment layers. But as the applied voltage is increased, the liquid crystal molecules 162 gradually get tilted radially with respect to the regions 122a and 122b of the pixel electrode 122. Furthermore, as the alignment regulating structures 142a and 142b are arranged on the counter substrate 140 so as to face approximately center portions of the region 122a and 122b of the pixel electrode 122, the radially tilted alignments of the liquid crystal molecules 162 can be stabilized. Such a mode is sometimes called a “CPA mode”.

In this liquid crystal display device 100A, the gate lines G may have a width of 4 μm and the storage capacitor lines CS may have a width of 10 μm, for example. Since the width of the storage capacitor lines CS are broader than that of the gate lines G, the magnitude of coupled capacitance to be formed with the capacitive coupling region of the semiconductor layer Se can be increased. Also, although each storage capacitor line CS runs between its associated two adjacent rows of pixels, each storage capacitor line CS faces a portion of the semiconductor layer Se for, and is associated with, only a single row of pixels. Although not shown in FIG. 1, a black matrix is actually arranged on the counter substrate 140 to shield the gate lines G, source lines S and storage capacitor lines CS.

The storage capacitor lines CS and the gate lines G, which made of the same metallic material, are formed in the same process step, and are often called collectively a “gate metal”. Likewise, the drain electrode 128 and the source lines S, which are made of the same metallic material, are formed in the same process step, and are often called collectively a “source metal”.

In the liquid crystal display device 100A of this embodiment, the conductive layer 130 is arranged to partially overlap with the gate lines G and is connected to the source lines S. The conductive layer 130 is made of the same material as the source lines S and the drain electrode 128 and forms part of the source metal. As viewed along a normal to the principal surface of the active-matrix substrate 120, the conductive layer 130 has a portion 130r that is located between the first and second regions 122a and 122b of the pixel electrode 122. That portion 130r of the conductive layer 130 is arranged to correspond to the slit 122s of the pixel electrode 122 and overlaps the gate line G. In this way, the portion 130r of the conductive layer 130 is not overlapped by the pixel electrode 122 but does overlap the gate line G.

Hereinafter, the multilayer structure of the active-matrix substrate 120 will be described in further detail. The semiconductor layer Se has been deposited on the transparent substrate 121. Optionally, a base coat (not shown) may be interposed between the transparent substrate 121 and the semiconductor layer Se.

An insulating layer 131 has been deposited on the semiconductor layer Se and the gate lines G and storage capacitor lines CS have been formed on the insulating layer 131. And portions of the insulating layer 131 function as a gate insulating film for the TFTs 125 and 126.

The gate lines G, storage capacitor lines CS and insulating layer 131 are further covered with another insulating layer 132, on which the source lines S, drain electrode 128 and conductive layer 130 have been formed. And the source metal including these members is covered with still another insulating layer 133, on which the pixel electrode 122 has been formed. If these two insulating layers 132 and 133 are collectively referred to herein as an “interlayer insulating layer 134”, then the conductive layer 130 is located in the interlayer insulating layer 134 between the gate lines G and the pixel electrode 122.

In this liquid crystal display device 100A, the write polarity is inverted one gate line after another. For example, after a positive polarity writing operation is performed on a target pixel, a negative polarity writing operation is performed on a pixel on the line adjacent to the target pixel. This type of driving is sometimes called “line inversion driving”. As used herein, “the positive polarity” means that the potential at a pixel electrode is higher than at the counter electrode. And a positive polarity writing operation will sometimes be referred to herein as a “positive write” operation. On the other hand, “the negative polarity” means that the potential at a pixel electrode is lower than at the counter electrode. And a negative polarity writing operation will sometimes be referred to herein as a “negative write” operation. According to the line inversion driving method, the potential at the counter electrode may be changed every horizontal scanning period. Then, power dissipation can be cut down with the amplitude of the potential on a source line reduced.

In addition, in this liquid crystal display device 100A, the polarity to be written is also inverted on a frame-by-frame basis. For example, if a positive polarity writing operation is performed on a target pixel in one frame, then a negative polarity writing operation will be performed on that pixel in the next frame. This type of driving is sometimes called “frame inversion driving”. By performing such line inversion driving and frame inversion driving, the flicker can be minimized.

Furthermore, this liquid crystal display device 100A is also driven by point sequential driving. A source driver that carries out the point sequential driving is disclosed in Japanese Patent Application Laid-Open Publication No. 2002-196360, for example. Generally speaking, according to the point sequential driving, writing operation can be performed on a pixel in a shorter time than by line sequential driving. In this embodiment, the semiconductor layer Se is made of polysilicon with a high carrier mobility, and the point sequential driving is adopted. By performing the point sequential driving in this manner, there is no need to provide a source driver for each and every source line, thus cutting down the cost. Nevertheless, the liquid crystal display device 100A does not always have to be driven by point sequential driving but may also be driven by line sequential driving. Or the liquid crystal display device 100A could even be driven by a fewer source drivers than the source lines. That type of driving is called “source shared driving”.

Hereinafter, advantages of the liquid crystal display device 100A of this embodiment over its counterparts of Comparative Examples 1 and 2 will be described.

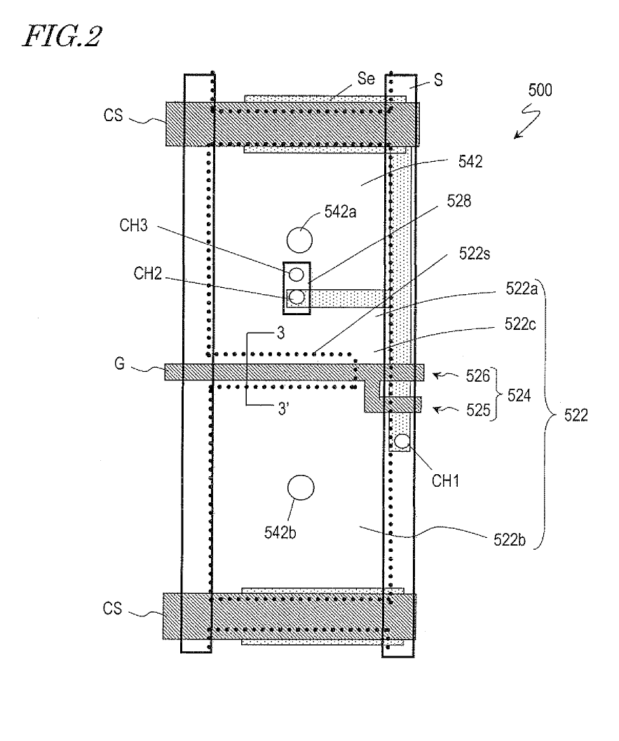

First, a liquid crystal display device 500 representing Comparative Example 1 will be described with reference to FIGS. 2 and 3. FIG. 2 is a schematic representation illustrating the liquid crystal display device 500 as Comparative Example 1. The liquid crystal display device 500 has the similar configuration as the liquid crystal display device 100A of this embodiment except that the device 500 does not include the conductive layer 130. And the overlapping description will be omitted herein to avoid redundancies. In this example, the liquid crystal display device 500 is supposed to be driven by line inversion driving, frame inversion driving and point sequential driving in combination. Also, to avoid overly complicating the description, the liquid crystal display device 500 is supposed to be driven so that the luminance of every pixel is maximized. In that case, the liquid crystal display device 500 displays white.

First of all, in one horizontal scanning period, a write operation is performed on a certain pixel, which will be referred to herein as a “target pixel” in the following description. The target pixel may be a pixel on the n^{th} row, for example. When a gate line G is selected, the gate line G associated with the target pixel has a potential of 8 V, thereby turning ON the TFTs 525 and 526 shown in FIG. 2. At this point in time, the potential on the source line S is set to be 2.8 V by a source driver (not shown), and the potential at the pixel electrode 522 also becomes 2.8 V. Meanwhile, the potential at the counter electrode 542 becomes −1.25 V. In that case, the voltage applied to the liquid crystal layer 560 (i.e., the absolute value of the potential difference between the pixel electrode 522 and the counter electrode 542) is 4.05 V.

After that, the gate line G will soon become a non-selected one, when the potential on the gate line G associated with the target pixel will decrease to −8 V. Then, the source driver will be electrically disconnected from the source line S, which will go floating in such a situation. Generally speaking, the potential on the gate line G has greater amplitude than the potential at any other electrode, thus minimizing the amount of OFF-state current to flow through TFTs and realizing high response speed.

Immediately after that, the potential at the counter electrode 542 rises from −1.25 V to 3.65 V. When the potential at the counter electrode 542 varies in this manner, the potential at the pixel electrode 522 varies, too. And the potential varies to the same degree both at the pixel electrode 522 and at the counter electrode 542. Specifically, the potential at the pixel electrode 522 varies from 2.8 V to 7.7 V.

Thereafter, in the next horizontal scanning period, a write operation is performed on the next line (e.g., on a pixel on the (n+1)^{th} row). At this point in time, the device is driven by line inversion driving, and the potential on the source line S that is connected to the source driver decreases to −0.4 V, which is lower than the potential (of 3.65 V) at the counter electrode 542. However, the gate line G associated with the target pixel is still non-selected and the potential on the gate line G remains −8 V. As a result, the TFTs 525 and 526 are still OFF and the potential at the pixel electrode 522 stays 7.7 V. In this case, the voltage applied to the liquid crystal layer 560 is 4.05 V.

Subsequently, a write operation is performed on the line after the next one (e.g., on a pixel on the (n+2)^{th} row). In response, the potential at the counter electrode 542 falls to −1.25 V and the potential on the source line S rises to 2.8 V. However, the gate line G associated with the target pixel is still non-selected and the potential on the gate line G remains −8 V. As a result, the TFTs 525 and 526 are still OFF and the potential at the pixel electrode 522 decreases to 2.8 V responsive to the potential variation at the counter electrode 542. In this case, the voltage applied to the liquid crystal layer 560 remains 4.05 V. After that, voltages will be written with the polarity inverted every line.

One frame after the positive write operation has been performed on the target pixel, a negative write operation will be written on that target pixel. And when the gate line G is selected, the potential on the gate line G will be 8 V, thereby turning ON the TFTs 525 and 526 shown in FIG. 2. The source driver decreases the potential on the source line S to −0.4 V, and the potential at the pixel electrode 522 also decreases to −0.4 V. Meanwhile, the potential at the counter electrode 542 is 3.65 V. In this case, the voltage applied to the liquid crystal layer 560 is 4.05 V.

After that, the gate line G will soon become a non-selected one, when the potential on the gate line G will decrease to −8 V. Then, the source driver will electrically disconnected from the source line S, which will go floating in such a situation.

Immediately after that, the potential at the counter electrode 542 falls from 3.65 V to −1.25 V. When the potential at the counter electrode 542 varies in this manner, the potential at the pixel electrode 522 varies, too. And the potential varies to the same degree both at the pixel electrode 522 and at the counter electrode 542. Specifically, the potential at the pixel electrode 522 varies from −0.4 V to −5.3 V.

Thereafter, a write operation is performed on the next line (e.g., on a pixel on the (n+1)^{th} row). At this point in time, the device is driven by line inversion driving, and the potential on the source line S that is connected to the source driver rises to 2.8 V, which is higher than the potential (of −1.25 V) at the counter electrode 542. However, the gate line G associated with the target pixel is still non-selected and the potential on the gate line G remains −8 V. As a result, the TFTs 525 and 526 are still OFF, the potential at the pixel electrode 522 stays −5.3 V and the potential at the counter electrode 542 is −1.25 V. In this case, the voltage applied to the liquid crystal layer 560 is 4.05 V.

Subsequently, a write operation is performed on the line after the next one (e.g., on a pixel on the (n+2)^{th} row). In response, the potential at the counter electrode 542 rises to 3.65 V. However, the gate line G associated with the target pixel is still non-selected and the potential on the gate line G remains −8 V. As a result, the TFTs 525 and 526 are still OFF and the potential at the pixel electrode 522 rises to −0.4 V responsive to the potential variation at the counter electrode 542. In this case, the voltage applied to the liquid crystal layer 560 remains 4.05 V. After that, voltages will be written in the same way.

The following Table 1 summarizes the variations in potential at the counter electrode 542, the pixel electrode 522, the source line S and the gate line G described above:

TABLE 1

| | | Potential | | | |
|---|---|---|---|---|---|
| | | at | Potential | | |
| | | counter | at pixel | Potential | Potential |
| | | electrode | electrode | on source | on gate |
| | | 542 | 522 | line S | line G |
| (a) | Positive | −1.25 V | 2.8 V | 2.8 V | 8 V |
| | write | | | | |
| | operation on | | | | |
| | target pixel | | | | |
| (b) | Right after | 3.65 V | 7.7 V | 7.7 V | −8 V |
| | gate line | | | | |
| | gets non- | | | | |
| | selected | | | | |
| (c) | Negative | 3.65 V | 7.7 V | −0.4 V | −8 V |
| | write | | | | |
| | operation on | | | | |
| | next line | | | | |
| (d) | Positive | −1.25 V | 2.8 V | 2.8 V | −8 V |
| | write | | | | |
| | operation on | | | | |
| | line after | | | | |
| | next one | | | | |
| | ↓ | | | | |
| (e) | Negative | 3.65 V | −0.4 V | −0.4 V | 8 V |
| | write | | | | |
| | operation on | | | | |
| | target pixel | | | | |
| (f) | Right after | −1.25 V | −5.3 V | −5.3 V | −8 V |
| | gate line | | | | |
| | gets non- | | | | |
| | selected | | | | |
| (g) | Positive | −1.25 V | −5.3 V | 2.8 V | −8 V |
| | write | | | | |
| | operation on | | | | |
| | next line | | | | |
| (h) | Negative | 3.65 V | −0.4 V | −0.4 V | −8 V |
| | write | | | | |
| | operation on | | | | |
| | line after | | | | |
| | next one | | | | |
| | ↓ | | | | |

Next, it will be described with reference to FIG. 3 how equipotential curves vary in the liquid crystal display device 500 representing Comparative Example 1. Portions (a) through (h) of FIG. 3 are cross-sectional views illustrating the liquid crystal display device 500 as Comparative Example 1 as viewed on the plane 3-3′ shown in FIG. 2 along with its equipotential curves. In FIG. 3, its portions (a) through (h) respectively correspond to the portions (a) through (h) of Table 1.

Let us compare portions (a) through (g) of FIG. 3 to portion (h) of FIG. 3. As the pixel electrode 522 has a slit 522s (see FIG. 2), the equipotential curves near the slit 522s of the pixel electrode 522 can be traced to fall into that slit 522s of the pixel electrode 522 as shown in portions (a) through (g) of FIG. 3. That is to say, the equipotential curves near the slit 522s of the pixel electrode 522 protrude downward with respect to that slit 522s of the pixel electrode 522. Alignment regulating force is applied to liquid crystal molecules 562 perpendicularly to those equipotential curves. That is why when such downwardly protruding equipotential curves can be traced, the liquid crystal molecules 562 that are located near the slit 522s of the pixel electrode 522 in the liquid crystal layer 560 will get aligned with other liquid crystal molecules 562, of which the tilt directions are controlled by alignment regulating structures 542a and 542b.

On the other hand, in portion (h) of FIG. 3, the equipotential curves near the slit 522s of the pixel electrode 522 can be traced so as to rise from the slit 522s of the pixel electrode 522. That is to say, these equipotential curves protrude upward with respect to that slit 522s of the pixel electrode 522. When such upwardly protruding equipotential curves can be traced, the liquid crystal molecules 562 that are located near the slit 522s of the pixel electrode 522 in the liquid crystal layer 560 will be misaligned with other liquid crystal molecules 562, of which the tilt directions are controlled by the alignment regulating structures 542a and 542b, thus eventually producing a residual image.

In the liquid crystal display device 500 representing Comparative Example 1 described above, the potential difference between the pixel electrode 522 and the counter electrode 542 is supposed to be 4.05 V and every pixel is supposed to have the highest luminance. In the following description, however, every pixel is supposed to have the lowest luminance. In that case, the liquid crystal display device 500 will display black, and the potential difference between the pixel electrode 522 and the counter electrode 542 may be 0.85 V, for example. By applying such a low voltage even when the luminance is the lowest, the response speed can be increased.

If a negative write operation is performed on a target pixel, the potential on the gate line G is 8 V, the potential at the counter electrode 542 is 3.65 V, and the potential at the pixel electrode 522 is 2.8 V. In that case, the voltage applied to the liquid crystal layer 560 (i.e., the potential difference between the counter electrode 542 and the pixel electrode 522) is 0.85 V.

After that, the gate line G will soon become a non-selected one, when the potential on the gate line G will decrease to −8 V. Then, the source driver will be electrically disconnected from the source line S, which will go floating in such a situation.

Immediately after that, the potential at the counter electrode 542 falls from 3.65 V to −1.25 V. When the potential at the counter electrode 542 varies in this manner, the potential at the pixel electrode 522 varies, too. And the potential varies to the same degree both at the pixel electrode 522 and at the counter electrode 542. Specifically, the potential at the pixel electrode 522 varies from 2.8 V to −2.1 V.

Thereafter, a write operation is performed on the next line (e.g., on a pixel on the (n+1)^{th} row). At this point in time, the device is driven by line inversion driving, and the potential on the source line S that is connected to the source driver changes to −0.4 V, which is higher than the potential (of −1.25 V) at the counter electrode 542. However, the gate line G associated with the target pixel is still non-selected and the potential on the gate line G remains −8 V. As a result, the TFTs 525 and 526 are still OFF, the potential at the pixel electrode 522 stays −2.1 V and the potential at the counter electrode 542 is −1.25 V. In this case, the voltage applied to the liquid crystal layer 560 is 0.85 V.

Subsequently, a write operation is performed on the line after the next one (e.g., on a pixel on the (n+2)^{th} row). In response, the potential at the counter electrode 542 rises to 3.65 V. However, the gate line G associated with the target pixel is still non-selected and the potential on the gate line G remains −8 V. As a result, the TFTs 525 and 526 are still OFF and the potential at the pixel electrode 522 rises to 2.8 V responsive to the potential variation at the counter electrode 542. In this case, the voltage applied to the liquid crystal layer 560 remains 0.85 V. After that, voltages will be written in the same way.

Portion (i) of FIG. 3 shows what equipotential curves can be traced in a situation where a negative write operation is performed on a target pixel and then a positive write operation is performed on another line (e.g., the (n+1)^{th} row). In that case, the potential at the counter electrode 542 is −1.25 V, the potential at the pixel electrode 522 is −2.1 V, and the potential on the gate line G is −8 V. Portion (i) of FIG. 3 corresponds to portion (g) of FIG. 3. Comparing these portions (i) and (g) of FIG. 3 to each other, it can be seen that the smaller the potential difference between the pixel electrode 522 and the counter electrode 542, the more significantly the equipotential curves traced near the slit 522s of the pixel electrode 522 tend protrude upward. That is why if the luminance is the lowest, the alignment is disturbed more easily than in a situation where the luminance is the highest.

And portion (j) of FIG. 3 shows what equipotential curves can be traced in a situation where a negative write operation is performed on a target pixel and then a negative write operation is performed on another line (e.g., the (n+2)^{th} line). In that case, the potential at the counter electrode 542 is 3.65 V, the potential at the pixel electrode 522 is 2.8 V, and the potential on the gate line G is −8 V. Portion (j) of FIG. 3 corresponds to portion (h) of FIG. 3. Comparing these portions (j) and (h) of FIG. 3 to each other, it can be seen that the smaller the potential difference between the pixel electrode 522 and the counter electrode 542, the more steeply the equipotential curves traced near the slit 522s of the pixel electrode 522 tend to protrude upward. That is why if the luminance is the lowest, the alignment is disturbed more extensively than in a situation where the luminance is the highest.

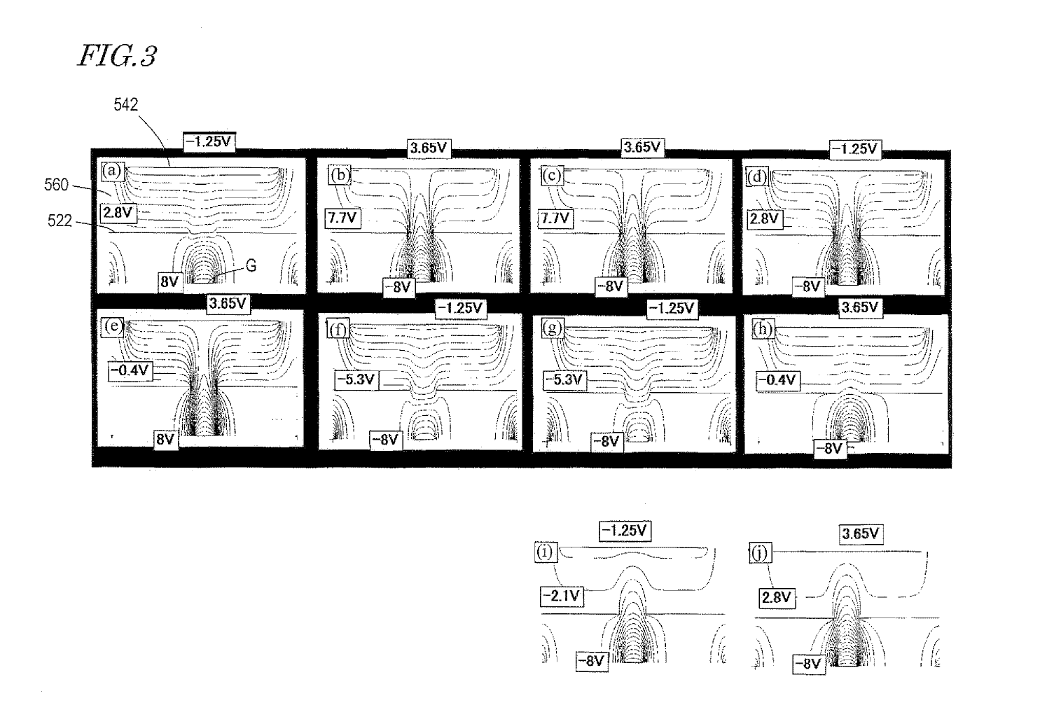

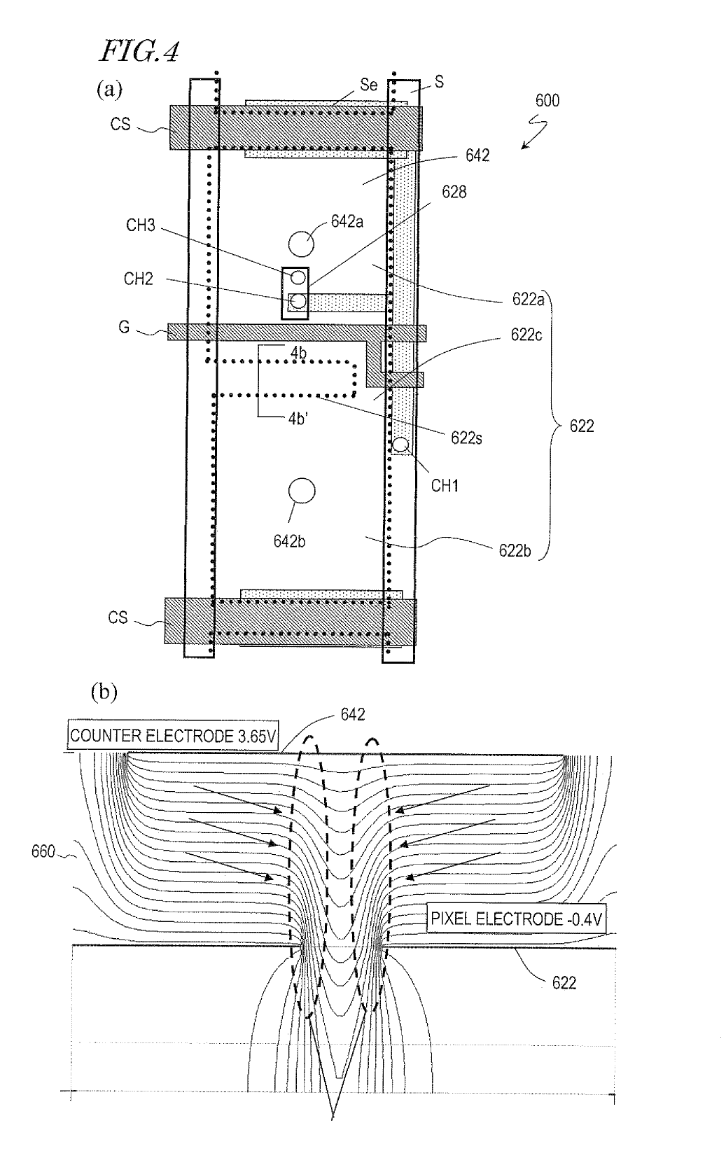

Next, a liquid crystal display device 600 representing Comparative Example 2 will be described with reference to FIG. 4. Specifically, FIG. 4(a) is a schematic representation illustrating the liquid crystal display device 600 as Comparative Example 2. This liquid crystal display device 600 has the similar configuration as its counterpart 100A of the embodiment described above except that in the former device 600, the gate line G is arranged to not correspond to the slit 622s of the pixel electrode 622 and is in overlapping relation with the first region 622a of the pixel electrode 622. Thus, the overlapping description will be omitted herein to avoid redundancies.

FIG. 4(b) illustrates a cross section of the liquid crystal display device 600 as Comparative Example 2 as viewed on the plane 4b-4b′ shown in FIG. 4(a) along with its equipotential curves. It should be noted that as the gate line G is arranged to not correspond to the slit 622s of the pixel electrode 622 in this liquid crystal display device 600, the gate line G is not shown in FIG. 4(b), in which the arrows indicate the alignment directions of liquid crystal molecules.

FIG. 4(b) shows what equipotential curves can be traced in a situation where a negative write operation is performed on a target pixel and then a negative write operation is performed on another line (e.g., the (n+2)^{th} line). In that case, the potential at the pixel electrode 622 is −0.4 V, the potential at the counter electrode 642 is 3.65 V, the voltage applied to the liquid crystal layer 660 (i.e., the absolute value of the potential difference between the pixel electrode 622 and the counter electrode 642) is 4.05 V, and the potential on the gate line G is −8 V.

In this liquid crystal display device 600, the gate line G is not in overlapping relation with the slit 622s of the pixel electrode 622. With the gate line G not aligned with the slit 622s of the pixel electrode 622 in this manner, even if the potential on the gate line G has great amplitude, liquid crystal molecules 662 around the slit 622s of the pixel electrode 622 will be hardly affected by the potential on the gate line G. And the equipotential curves to be drawn near the slit 622s of the pixel electrode 622 will protrude downward. As a result, as shown in FIG. 4(b), the liquid crystal molecules 662 located near the slit 622s of the pixel electrode 622 in the liquid crystal layer 660 will be aligned with the liquid crystal molecules 662, of which the tilt directions are controlled by the alignment regulating structures 642a and 642b, and will have their alignment much less disturbed. Consequently, residual image can be reduced significantly.

In the liquid crystal display device 600 of Comparative Example 2, however, the gate line G is overlapped by the first region 622a of the pixel electrode 622. That is why the black matrix to shield the gate line G overlaps with the first region 622a of the pixel electrode 622, thus eventually decreasing the aperture ratio.

On the other hand, in the liquid crystal display device 100A of this embodiment, the gate line G is arranged to correspond to the slit 122s of the pixel electrode 122, and therefore, the decrease in aperture ratio can be minimized. In addition, in the liquid crystal display device 100A, a conductive layer 130, which is connected to the source line S, is further provided to cover the gate line G. Since the amplitude of the potential on the source line S is smaller than that of the potential on the gate line G as described above, the conductive layer 130 that is connected to the source line S reduces the influence of the potential on the gate line G. As a result, the alignment will be much less disturbed.

Hereinafter, it will be described specifically how the potentials at the counter electrode 142, the pixel electrode 122, the conductive layer 130, the source line S and the gate line G vary in the liquid crystal display device 100A. To avoid overly complicating the description, the liquid crystal display device 100A is supposed to be driven so that the luminance of every pixel is maximized.

First of all, in one horizontal scanning period, a written operation is performed on a target pixel. In this example, the target pixel is supposed to be a pixel on the n^{th} row. When a gate line G is selected, the gate line G has a potential of 8 V, thereby turning ON the TFTs 125 and 126 shown in FIG. 1(a). At this point in time, the potential at the pixel electrode 122 is as high as the ones on the source line S and in the conductive layer 130, which are set to be 2.8 V by the source driver. And the potential at the pixel electrode 122 also becomes 2.8 V. Meanwhile, the potential at the counter electrode 142 becomes −1.25 V. In that case, the voltage applied to the liquid crystal layer 160 is 4.05 V.

After that, the gate line G will soon become a non-selected one, when the potential on the gate line G will decrease to −8 V. Then, the source driver will be electrically disconnected from the source line S, which will go floating in such a situation.

Immediately after that, the potential at the counter electrode 142 rises from −1.25 V to 3.65 V. When the potential at the counter electrode 142 varies in this manner, the potential at the pixel electrode 122 and the potential in the conductive layer 130 that is connected to the source line S vary, too. And the potentials at the pixel electrode 122 and in the conductive layer 130 vary to the same degree as the one at the counter electrode 142. Specifically, the potentials at the pixel electrode 122 and in the conductive layer 130 vary from 2.8 V to 7.7 V.

Thereafter, a write operation is performed on the next line (e.g., on a pixel on the (n+1)^{th} row). At this point in time, the device is driven by line inversion driving, and the potential on the source line S that is connected to the source driver is lower than the potential at the counter electrode 142. Specifically, the potential at the counter electrode 142 is 3.65 V, whereas the potentials on the source line S and in the conductive layer 130 connected to the source line S are −0.4 V. The gate line G associated with the target pixel is still non-selected and the potential on the gate line G remains −8 V. As a result, the TFTs 125 and 126 are still OFF and the pixel electrode 122 is not electrically connected to the source line S or the conductive layer 130. The potential at the pixel electrode 122 stays 7.7 V. In this case, the voltage applied to the liquid crystal layer 160 is 4.05 V.

Subsequently, a write operation is performed on the line after the next one (e.g., on a pixel on the (n+2)^{th} row). In response, the potential at the counter electrode 142 falls to −1.25 V. However, the gate line G associated with the target pixel is still non-selected and the potential on the gate line G remains −8 V. As a result, the TFTs 125 and 126 are still OFF and the potential at the pixel electrode 122 decreases to 2.8 V responsive to the potential variation at the counter electrode 142. In this case, the voltage applied to the liquid crystal layer 160 remains 4.05 V. After that, voltages will be written in a similar manner.

One frame after the positive write operation has been performed on the target pixel, a negative write operation will be performed on that target pixel. And when the gate line G is selected, the potential on the gate line G will be 8 V, thereby turning ON the TFTs 125 and 126 shown in FIG. 1(a) and equalizing the potential at the pixel electrode 122 with that of the conductive layer 130. At this point in time, the source driver decreases the potentials on the source line S and in the conductive layer 130 to −0.4 V, and the potential at the pixel electrode 122 also decreases to −0.4 V. Meanwhile, the potential at the counter electrode 142 is 3.65 V. In this case, the voltage applied to the liquid crystal layer 160 is 4.05 V.

After that, the gate line G will soon become a non-selected one, when the potential on the gate line G will decrease to −8 V. Then, the source driver will be electrically disconnected from the source line S, which will go floating in such a situation.

Immediately after that, the potential at the counter electrode 142 falls from 3.65 V to −1.25 V. When the potential at the counter electrode 142 varies in this manner, the potential at the pixel electrode 122 and the potential in the conductive layer 130 that is connected to the source line S vary, too. And the potentials at the pixel electrode 122 and conductive layer 130 vary to the same degree as the potential at the counter electrode 142. Specifically, the potentials at the pixel electrode 122 and conductive layer 130 vary from −0.4 V to −5.3 V.

Thereafter, a write operation is performed on the next line (e.g., on a pixel on the (n+1)^{th} row). At this point in time, the device is driven by line inversion driving, and the potential on the source line S that is connected to the source driver is higher than the potential at the counter electrode 142. Specifically, the potential at the counter electrode 142 is −1.25 V, whereas the potentials on the source line S and in the conductive layer 130 connected to the source line S are 2.8 V. The gate line G associated with the target pixel is still non-selected and the potential on the gate line G remains −8 V. As a result, the TFTs 125 and 126 are still OFF and the pixel electrode 122 is not electrically connected to the source line S or the conductive layer 130. The potential at the pixel electrode 122 stays −5.3 V. In this case, the voltage applied to the liquid crystal layer 160 is 4.05 V.

Subsequently, a write operation is performed on the line after the next one (e.g., on a pixel on the (n+2)^{th} row). In response, the potential at the counter electrode 142 rises to 3.65 V. However, the gate line G associated with the target pixel is still non-selected and the potential on the gate line G remains −8 V. As a result, the TFTs 125 and 126 are still OFF and the potential at the pixel electrode 122 rises to −0.4 V responsive to the potential variation at the counter electrode 142. In this case, the voltage applied to the liquid crystal layer 160 remains 4.05 V. After that, voltages will be written in the same way.

The following Table 2 summarizes the variations in potential at the counter electrode 142, the pixel electrode 122, the conductive layer 130 and the gate line G described above:

TABLE 2

| | | Potential | Potential | Potential | |
|---|---|---|---|---|---|
| | | at counter | at pixel | in | Potential |
| | | electrode | electrode | conductive | on gate |
| | | 142 | 122 | layer 130 | line G |
| (a) | Positive write | −1.25 V | 2.8 V | 2.8 V | 8 V |
| | operation on | | | | |
| | target pixel | | | | |
| (b) | Right after | 3.65 V | 7.7 V | 7.7 V | −8 V |
| | gate line gets | | | | |
| | non-selected | | | | |
| (c) | Negative write | 3.65 V | 7.7 V | −0.4 V | −8 V |
| | operation on | | | | |
| | next line | | | | |
| (d) | Positive write | −1.25 V | 2.8 V | 2.8 V | −8 V |
| | operation on | | | | |
| | line after | | | | |
| | next one | | | | |
| | ↓ | | | | |
| (e) | Negative write | 3.65 V | −0.4 V | −0.4 V | 8 V |
| | operation on | | | | |
| | target pixel | | | | |
| (f) | Right after | −1.25 V | −5.3 V | −5.3 V | −8 V |
| | gate line gets | | | | |
| | non-selected | | | | |
| (g) | Positive write | −1.25 V | −5.3 V | 2.8 V | −8 V |
| | operation on | | | | |
| | next line | | | | |
| (h) | Negative write | 3.65 V | −0.4 V | −0.4 V | −8 V |
| | operation on | | | | |
| | line after | | | | |
| | next one | | | | |
| | ↓ | | | | |

Next, it will be described with reference to FIG. 5 how equipotential curves vary in the liquid crystal display device 100A. Portions (a) through (h) of FIG. 5 are cross-sectional views illustrating the liquid crystal display device 100A as viewed on the plane 1c-1c′ shown in FIG. 1(a) along with its equipotential curves. In FIG. 5, its portions (a) through (h) respectively correspond to the portions (a) through (h) of Table 2.

As can be seen from portions (a) through (h) of FIG. 5, in the liquid crystal display device 100A of this embodiment, equipotential curves traced around the slit 122s of the pixel electrode 122 protrude downward, and therefore, the alignment is not disturbed. In this liquid crystal display device 100A, the slit 122s of the pixel electrode 122 does overlap with the gate line G but a conductive layer 130, which is connected to the source line 5, is arranged in the interlayer insulating layer 134 between the gate line G and the pixel electrode 122. That is why the electric field generated by the gate line G is substantially cut off by the conductive layer 130 and the equipotential curves traced around the slit 122s of the pixel electrode 122 protrude downward. As a result, in the liquid crystal layer 160, the liquid crystal molecules 162 near the slit 122s of the pixel electrode 122 will be aligned with the other liquid crystal molecules 162, of which the tilt directions are controlled by the first and second regions 122a and 122b of the pixel electrode 122 and the alignment regulating structures 142a and 142b. Consequently, the alignment of the liquid crystal molecules 162 is much less disturbed in the vicinity of the slit 122s of the pixel electrode 122.

Particularly if a negative write operation is performed on the target pixel and then on another pixel, the equipotential curves drawn near the slit 522s of the pixel electrode 522 protrude upward in the liquid crystal display device 500 of Comparative Example 1 as shown in portion (h) of FIG. 3. On the other hand, in the liquid crystal display device 100A of this embodiment, even when the potentials on the gate line G, the pixel electrode 122, and the counter electrode 142 are the same as in the liquid crystal display device 500 of Comparative Example 1, the equipotential curves drawn near the slit 122s of the pixel electrode 122 still protrude downward as shown in portion (h) of FIG. 5 and the alignment is much less disturbed. In this manner, the influence of the gate line G can be substantially eliminated by the conductive layer 130. Consequently, in the liquid crystal display device 100A, even if the slit 122s of the pixel electrode 122 is arranged to correspond to the gate line G to minimize the decrease in aperture ratio, disturbance of alignment can be minimized.

In the above description, the liquid crystal display device 100A is supposed to be driven so that the luminance of every pixel is maximized. In the following description, however, the liquid crystal display device 100A will be driven so that luminance of every pixel is minimized.

First of all, in one horizontal scanning period, a write operation is performed on a target pixel. When a gate line G is selected, the gate line G has a potential of 8 V, thereby turning ON the TFTs 125 and 126 shown in FIG. 1(a). At this point in time, the potential at the pixel electrode 122 is as high as that of the conductive layer 130. In this case, the source driver sets the potentials on the source line S and conductive layer 130 to be −0.4 V, and the potential at the pixel electrode 122 is also −0.4 V. Meanwhile, the potential at the counter electrode 142 becomes −1.25 V. In that case, the voltage applied to the liquid crystal layer 160 is 0.85 V.

After that, the gate line G will soon become a non-selected one, when the potential on the gate line G will decrease to −8 V. Then, the source driver will be electrically disconnected from the source line S, which will go floating in such a situation.

Immediately after that, the potential at the counter electrode 142 rises from −1.25 V to 3.65 V. When the potential at the counter electrode 142 varies in this manner, the potential at the pixel electrode 122 and the potential in the conductive layer 130 that is connected to the source line S vary, too. And the potentials at the pixel electrode 122 and in the conductive layer 130 vary to the same degree as the one at the counter electrode 142. Specifically, the potentials at the pixel electrode 122 and in the conductive layer 130 vary from −0.4 V to 4.5 V.

Thereafter, a write operation is performed on the next line (e.g., on a pixel on the (n+1)^{th} row). At this point in time, the device is driven by line inversion driving, and the potential on the source line S that is connected to the source driver is lower than the potential at the counter electrode 142. Specifically, the potential at the counter electrode 142 is 3.65 V, whereas the potentials on the source line S and in the conductive layer 130 connected to the source line S are 2.8 V. The gate line G associated with the target pixel is still non-selected and the potential on the gate line G remains −8 V. As a result, the TFTs 125 and 126 are still OFF and the pixel electrode 122 is not electrically connected to the source line S or the conductive layer 130. The potential at the pixel electrode 122 stays 4.5 V. In this case, the voltage applied to the liquid crystal layer 160 is 0.85 V.

Subsequently, a write operation is performed on the line after the next one (e.g., on a pixel on the (n+2)^{th} row). In response, the potential at the counter electrode 142 falls to −1.25 V. However, the gate line G associated with the target pixel is still non-selected and the potential on the gate line G remains −8 V. As a result, the TFTs 125 and 126 are still OFF and the potential at the pixel electrode 122 decreases to −0.4 V responsive to the potential variation at the counter electrode 142. In this case, the voltage applied to the liquid crystal layer 160 remains 0.85 V. After that, voltages will be written in a similar manner.

One frame after the positive write operation has been performed on the target pixel, a negative write operation will be performed on that target pixel. And when the gate line G is selected, the potential on the gate line G will be 8 V, thereby turning ON the TFTs 125 and 126 shown in FIG. 1(a) and equalizing the potential at the pixel electrode 122 with that of the conductive layer 130. At this point in time, the source driver raises the potentials on the source line S and in the conductive layer 130 to 2.8 V, and the potential at the pixel electrode 122 also increases to 2.8 V. Meanwhile, the potential at the counter electrode 142 is 3.65 V. In this case, the voltage applied to the liquid crystal layer 160 is 0.85 V.

After that, the gate line G will soon become a non-selected one, when the potential on the gate line G will decrease to −8 V. Then, the source driver will be electrically disconnected from the source line S, which will go floating in such a situation.

Immediately after that, before a write operation is performed on the next line (e.g., on a pixel on the (n+1)^{th} row), the potential at the counter electrode 142 falls from 3.65 V to −1.25 V. When the potential at the counter electrode 142 varies in this manner, the potential at the pixel electrode 122 and the potential in the conductive layer 130 that is connected to the source line S vary, too. And the potentials at the pixel electrode 122 and conductive layer 130 vary to the same degree as the potential at the counter electrode 142. Specifically, the potentials at the pixel electrode 122 and conductive layer 130 vary from 2.8 V to −2.1 V.

Thereafter, a write operation is performed on the next line (e.g., on a pixel on the (n+1)^{th} row). At this point in time, the device is driven by line inversion driving, and the potential on the source line S that is connected to the source driver is higher than the potential at the counter electrode 142. Specifically, the potential at the counter electrode 142 is −1.25 V, whereas the potentials on the source line S and in the conductive layer 130 connected to the source line S are −0.4 V. The gate line G associated with the target pixel is still non-selected and the potential on the gate line G remains −8 V. As a result, the TFTs 125 and 126 are still OFF and the pixel electrode 122 is not electrically connected to the source line S or the conductive layer 130. The potential at the pixel electrode 122 stays −2.1 V. In this case, the voltage applied to the liquid crystal layer 160 is 0.85 V.

Subsequently, a write operation is performed on the line after the next one (e.g., on a pixel on the (n+2)^{th} row). In response, the potential at the counter electrode 142 rises to 3.65 V. However, the gate line G associated with the target pixel is still non-selected and the potential on the gate line G remains −8 V. As a result, the TFTs 125 and 126 are still OFF and the potential at the pixel electrode 122 rises to 2.8 V responsive to the potential variation at the counter electrode 142. In this case, the voltage applied to the liquid crystal layer 160 remains 0.85 V. After that, voltages will be written in the same way.

The following Table 3 summarizes the variations in potential at the counter electrode 142, the pixel electrode 122, the conductive layer 130 and the gate line G described above:

TABLE 3

| | | Potential | Potential | Potential | |
|---|---|---|---|---|---|
| | | at counter | at pixel | in | Potential |
| | | electrode | electrode | conductive | on gate |
| | | 142 | 122 | layer 130 | line G |
| (a) | Positive write | −1.25 V | −0.4 V | −0.4 V | 8 V |
| | operation on | | | | |
| | target pixel | | | | |
| (b) | Right after | 3.65 V | 4.5 V | 4.5 V | −8 V |
| | gate line gets | | | | |
| | non-selected | | | | |
| (c) | Negative write | 3.65 V | 4.5 V | 2.8 V | −8 V |
| | operation on | | | | |
| | next line | | | | |
| (d) | Positive write | −1.25 V | −0.4 V | −0.4 V | −8 V |
| | operation on | | | | |
| | line after next | | | | |
| | one | | | | |
| | ↓ | | | | |
| (e) | Negative write | 3.65 V | 2.8 V | 2.8 V | 8 V |
| | operation on | | | | |
| | target pixel | | | | |
| (f) | Right after | −1.25 V | −2.1 V | −2.1 V | −8 V |
| | gate line gets | | | | |
| | non-selected | | | | |
| (g) | Positive write | −1.25 V | −2.1 V | −0.4 V | −8 V |
| | operation on | | | | |
| | next line | | | | |
| (h) | Negative write | 3.65 V | 2.8 V | 2.8 V | −8 V |
| | operation on | | | | |
| | line after next | | | | |
| | one | | | | |
| | ↓ | | | | |

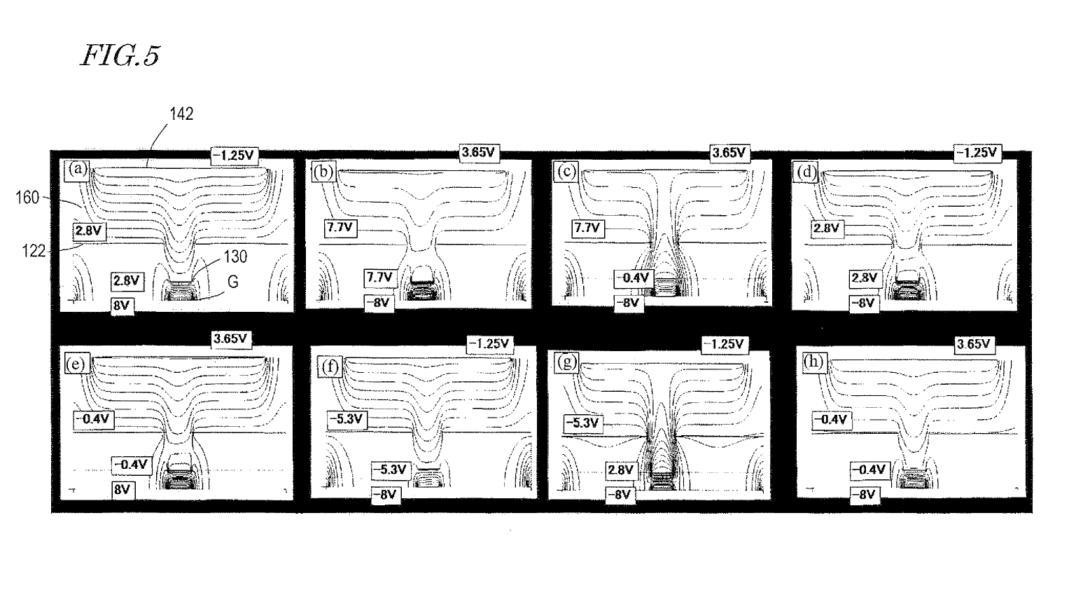

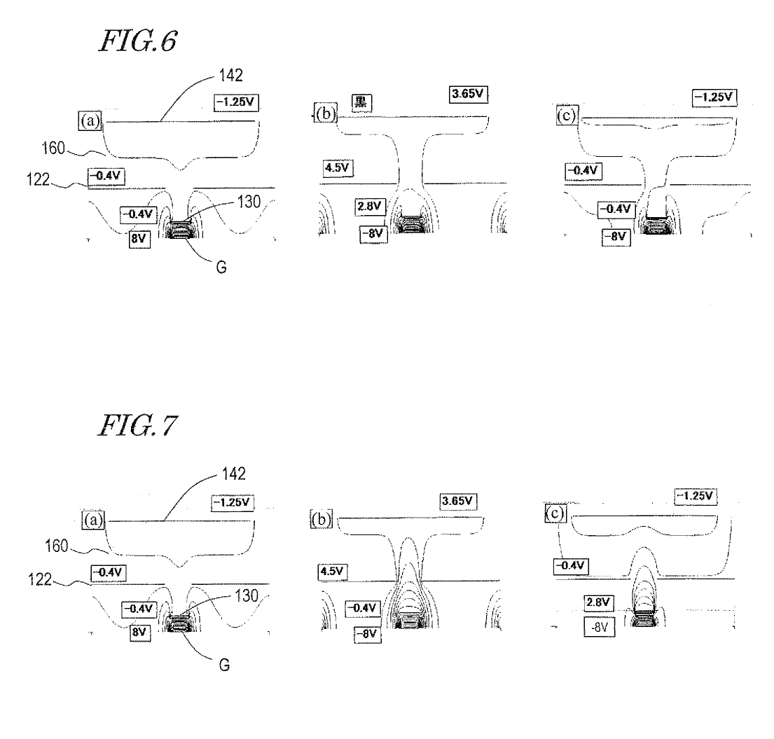

FIG. 6 illustrates equipotential curves to be traced in this liquid crystal display device 100A. In FIG. 6, its portions (a), (b) and (c) respectively correspond to the portions (a), (c) and (d) of Table 3.

As can be seen from portions (a) through (c) of FIG. 6, in this case, equipotential curves traced around the slit 122s of the pixel electrode 122 also protrude downward, and therefore, the alignment is not disturbed. Although not shown in FIG. 6, the alignment is not disturbed, either, even in the situations (e) through (h) of Table 3.

In the foregoing description, after a negative write operation has been performed on the target pixel, the alignment is supposed to be disturbed in the liquid crystal display device 500 of Comparative Example 1 as shown in portions (h) and (j) of FIG. 3, but not disturbed in the liquid crystal display device 100A. Strictly speaking, even in the liquid crystal display device 100A, the alignment could be disturbed in some situations. Hereinafter, it will be described exactly in what situations the alignment could be disturbed in this liquid crystal display device 100A.

First of all, let us consider in what conditions the alignment could be disturbed. Suppose the potentials at the counter electrode, the pixel electrode and the conductive member, which is located under the slit of the pixel electrode, are identified by D₁, D₂ and D₃, respectively. In this case, D₃ represents the potential on the gate line G in the liquid crystal display device 500 of Comparative Example 1 and also represents the potential in the conductive layer 130 of the liquid crystal display device 100A.

As described above, in the liquid crystal display device 500 of Comparative Example 1, the equipotential curves protrude upward with respect to the slit 522s of the pixel electrode 522 in portions (h), (i) and (j) of FIG. 3 and the alignment is disturbed. In such a situation, D₁, D₂ and D₃ satisfy the inequality D₁>D₂>D₃. On the other hand, even if the inequality D₁<D₂<D₃ is satisfied, the alignment could also be disturbed as well. That is why if the alignment is disturbed, D₁, D₂ and D₃ may satisfy either D₁>D₂>D₃ or D₁<D₂<D₃. Nevertheless, this does not mean that as long as either D₁>D₂>D₃ or D₁<D₂<D₃ is satisfied, the alignment is always disturbed. For example, in portion (a) of FIG. 3 illustrating the equipotential curves to be traced in the liquid crystal display device 500 of Comparative Example 1, D₁, D₂ and D₃ do satisfy D₁<D₂<D₃ but the alignment is not disturbed. Thus, even if either D₁>D₂>D₃ or D₁<D₂<D₃ is satisfied, the alignment may not be disturbed according to the thicknesses of respective films and the potential values.

On the other hand, as can be seen from Tables 2 and 3, in this liquid crystal display device 100A, if every pixel has the highest or lowest luminance, D₁, D₂ and D₃ satisfy neither D₁>D₂>D₃ nor D₁<D₂<D₃. This also tells that the alignment is much less disturbed in the liquid crystal display device 100A.

Nonetheless, it does not mean that in the liquid crystal display device 100A, D₁, D₂ and D₃ never satisfy D₁>D₂>D₃ or D₁<D₂<D₃. In the liquid crystal display device 100 described above, every pixel is supposed to have either the highest luminance or the lowest luminance. However, some pixels could have a different luminance from the other pixels. In the following example, the target pixel and the line adjacent to the target pixel are supposed to have the lowest luminance and the next line is supposed to have the highest luminance. The following Table 4 summarizes how potentials vary at the counter electrode 142, the pixel electrode 122, the conductive layer 130 and the gate line B in such a situation:

TABLE 4

| | | Potential | Potential | Potential | |
|---|---|---|---|---|---|
| | | at counter | at pixel | in | Potential |
| | | electrode | electrode | conductive | on gate |
| | | 142 | 122 | layer 130 | line G |
| (a) | Write positive | −1.25 V | −0.4 V | −0.4 V | 8 V |
| | black voltage | | | | |
| | on target | | | | |
| | pixel | | | | |
| (b) | Right after | 3.65 V | 4.5 V | 4.5 V | −8 V |
| | gate line gets | | | | |
| | non-selected | | | | |
| (c) | Write negative | 3.65 V | 4.5 V | −0.4 V | −8 V |
| | white voltage | | | | |
| | on next line | | | | |
| (d) | Write positive | −1.25 V | −0.4 V | 2.8 V | −8 V |
| | white voltage | | | | |
| | on line after | | | | |
| | next one | | | | |
| | ↓ | | | | |
| (e) | Write negative | 3.65 V | 2.8 V | 2.8 V | 8 V |
| | black voltage | | | | |
| | on target | | | | |
| | pixel | | | | |
| (f) | Right after | −1.25 V | −2.1 V | −2.1 V | −8 V |
| | gate line gets | | | | |
| | non-selected | | | | |
| (g) | Write positive | −1.25 V | −2.1 V | 2.8 V | −8 V |
| | white voltage | | | | |
| | on next line | | | | |
| (h) | Write negative | 3.65 V | 2.8 V | −0.4 V | −8 V |
| | white voltage | | | | |
| | on line after | | | | |
| | next one | | | | |
| | ↓ | | | | |

FIG. 7 illustrates equipotential curves to be traced in this liquid crystal display device 100A. In FIG. 7, its portions (a), (b) and (c) respectively correspond to the portions (a), (c) and (d) of Table 4.

As shown in portion (c) of FIG. 7, the equipotential curves protrude upward with respect to the slit 122s of the pixel electrode 122 and the alignment is disturbed. In this case, D₁, D₂ and D₃ satisfy D₁<D₂<D₃. As can be seen, if a positive write operation is performed on the target pixel with low luminance and then written on a pixel on another line with high luminance, the equipotential curves of the target pixel will also protrude upward with respect to the slit 122s of the pixel electrode 122.

Likewise, if a negative write operation is performed on the target pixel with low luminance and then written on a pixel on another line with high luminance, D₁, D₂ and D₃ satisfy D₃>D₂>D₃ as can be seen from portion (h) of Table 4. In that case, the equipotential curves of the target pixel will also protrude upward with respect to the slit 122s of the pixel electrode 122.

In still another example, the line including the target pixel may have the lowest luminance, while the next line adjacent to that target pixel and the line after the next one may have the highest luminance. The following Table 5 summarizes how the potentials at the counter electrode 142, the pixel electrode 122, the conductive layer 130 and the gate line G vary in such a situation:

TABLE 5

| | | Potential | Potential | Potential | |
|---|---|---|---|---|---|
| | | at counter | at pixel | in | Potential |
| | | electrode | electrode | conductive | on gate |
| | | 142 | 122 | layer 130 | line G |
| (a) | Write positive | −1.25 V | −0.4 V | −0.4 V | 8 V |
| | black voltage | | | | |
| | on target | | | | |
| | pixel | | | | |
| (b) | Right after | 3.65 V | 4.5 V | 4.5 V | −8 V |
| | gate line gets | | | | |
| | non-selected | | | | |
| (c) | Write negative | 3.65 V | 4.5 V | 2.8 V | −8 V |
| | black voltage | | | | |
| | on next line | | | | |
| (d) | Write positive | −1.25 V | −0.4 V | 2.8 V | −8 V |
| | white voltage | | | | |
| | on line after | | | | |
| | next one | | | | |
| | ↓ | | | | |
| (e) | Write negative | 3.65 V | 2.8 V | 2.8 V | 8 V |
| | black voltage | | | | |
| | on target | | | | |
| | pixel | | | | |
| (f) | Right after | −1.25 V | −2.1 V | −2.1 V | −8 V |
| | gate line gets | | | | |
| | non-selected | | | | |
| (g) | Write positive | −1.25 V | −2.1 V | −0.4 V | −8 V |
| | black voltage | | | | |
| | on next line | | | | |
| (h) | Write negative | 3.65 V | 2.8 V | −0.4 V | −8 V |
| | white voltage | | | | |
| | on line after | | | | |
| | next one | | | | |
| | ↓ | | | | |

It should be noted that portions (a), (c) and (d) of this Table 5 correspond to portion (a) of FIG. 7, portion (b) of FIG. 6 and portion (c) of FIG. 7, respectively. As can be seen, if a positive write operation is performed on the target pixel with low luminance and then written on a pixel on another line with high luminance, the equipotential curves will also protrude upward with respect to the slit 122s of the pixel electrode 122 and the alignment is disturbed as can be seen from portion (c) of FIG. 7 corresponding to portion (d) of Table 5. In this case, D₁, D₂ and D₃ satisfy the inequality D₁<D₂<D₃. On the other hand, if a negative write operation is performed on the target pixel with low luminance and then written on a pixel on another line with high luminance, D₁, D₂ and D₃ satisfy the inequality D₁>D₂>D₃ as can be seen from portion (h) of Table 5.

As described above, even the liquid crystal display device 100A may sometimes satisfy D₁>D₂>D₃ or D₁<D₂<D₃. Even so, the liquid crystal display device 100A satisfies it for no longer than one horizontal scanning period on end. That is to say, the inequality is not satisfied every other horizontal scanning period. Consequently, the display operation is not actually affected significantly. On the other hand, in the liquid crystal display device 500 of Comparative Example 1, while a write operation is being performed on a pixel other than the target one on which a negative write operation has already been performed, the equipotential curves protrude upward with respect to the slit of the pixel electrode and the alignment is disturbed.

### Embodiment 2

In the above description, the conductive layer 130 is connected to the source line S. However, the present invention is in no way limited to it. The conductive layer 130 could also be connected to the drain electrode 128.

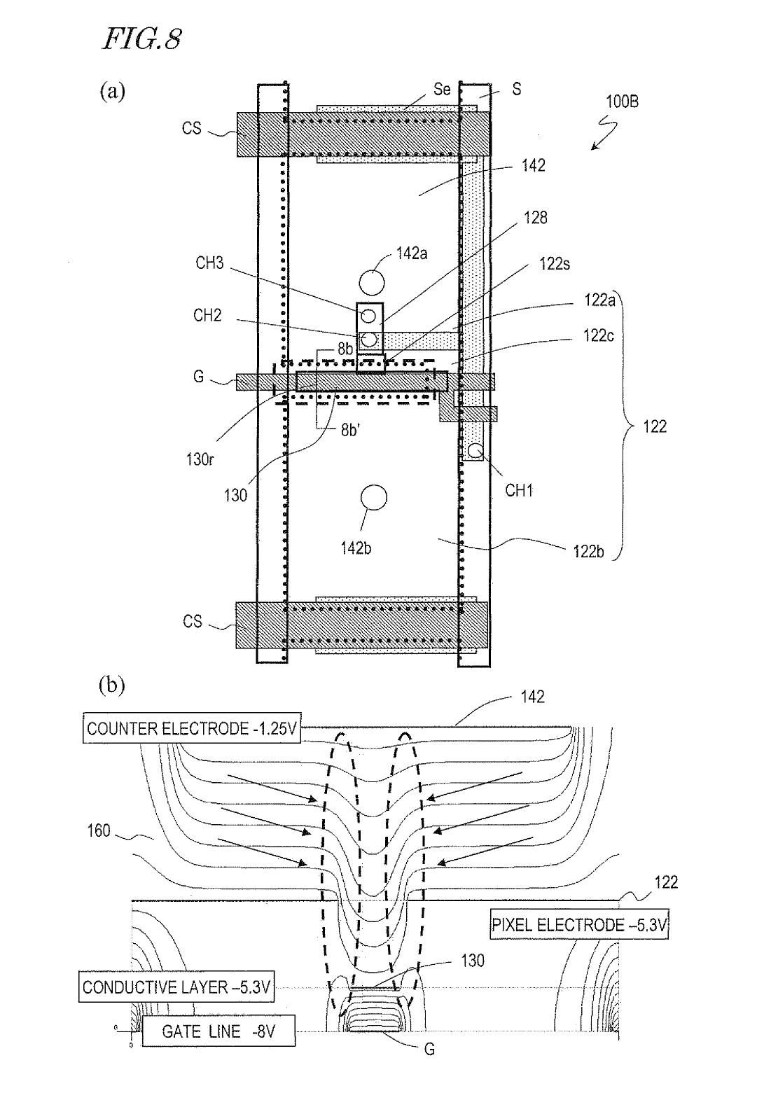

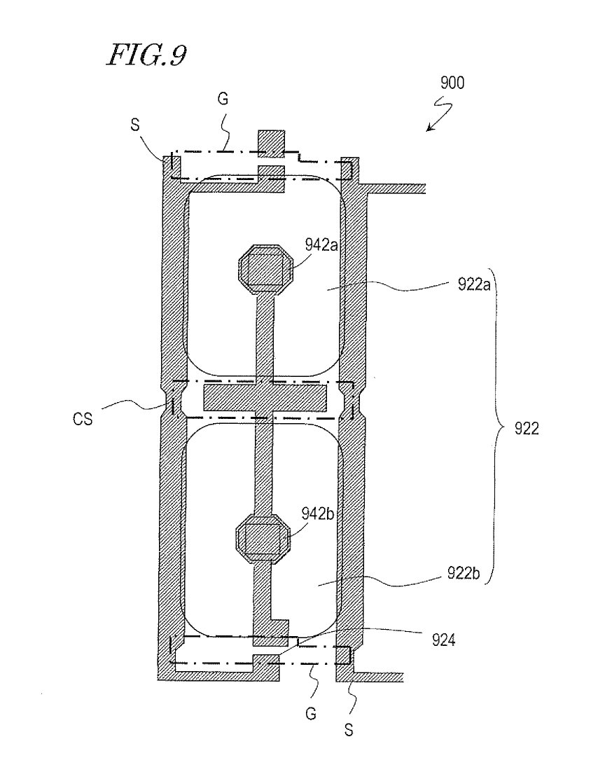

Hereinafter, a liquid crystal display device 100B as a second embodiment of the present invention will be described with reference to FIG. 8. Specifically, FIG. 8(a) is a schematic representation illustrating the liquid crystal display device 100B, which has the similar configuration as the liquid crystal display device 100A described above except that the conductive layer 130, which is arranged to correspond to the slit 122s of the pixel electrode 122, is connected to the drain electrode 128, instead of the source line S. Thus, the overlapping description will be omitted herein to avoid redundancies.

In this liquid crystal display device 100B, as viewed along a normal to the principal surface of the active-matrix substrate 120, the conductive layer 130 also has a portion 130r that is located between the first and second regions 122a and 122b of the pixel electrode 122. That portion 130r of the conductive layer 130 is arranged to correspond to the slit 122s of the pixel electrode 122 and overlaps the gate line G. That is to say, the portion 130r of the conductive layer 130 is not overlapped by the pixel electrode 122 but does overlap the gate line G. In this liquid crystal display device 100B, however, the conductive layer 130 is connected to the drain electrode 128 that is electrically connected to the pixel electrode 122.

FIG. 8(b) illustrates a cross-sectional view of the liquid crystal display device 100B as viewed on the plane 8b-8b′ shown in FIG. 8(a) along with its equipotential curves to be traced in a situation where a negative write operation is performed on the target pixel and then a negative write operation is performed on another pixel. In FIG. 8(b), the arrows indicate the alignment directions of the liquid crystal molecules.

In this case, potentials at the counter electrode 142, the pixel electrode 122, the conductive layer 130 and the gate line G are −1.25 V, −5.3 V, −5.3 V and −8 V, respectively. In this liquid crystal display device 100B, the equipotential curves traced around the slit 122s of the pixel electrode 122 also protrude downward, and therefore, the alignment is not disturbed, either.

Supposing the potentials at the counter electrode 142, the pixel electrode 122 and the conductive layer 130 are identified by D₁, D₂ and D₃, respectively, the liquid crystal display device 100A described above satisfies the inequality D₁>D₂>D₃ or D₁<D₂<D₃ in some periods. On the other hand, in this liquid crystal display device 100B, D₂=D₃ is always satisfied and there are no periods at all in which D₁>D₂>D₃ or D₁<D₂<D₃ is satisfied. As a result, the alignment is much less disturbed.

In the above description, the conductive layer 130 forms part of the source metal. However, the present invention is in no way limited to it. The conductive layer 130 could also form part of the gate metal. Nevertheless, it is preferred that the potential in the conductive layer 130 be equal to or lower than the one at the pixel electrode 122, which is higher than the potential at the counter electrode 142, when a positive write operation is performed, and be equal to or higher than the potential at the pixel electrode 122, which is lower than the one at the counter electrode 142, when a negative write operation is performed. The potential at the counter electrode 142 may vary in the same phase as that of a storage capacitor signal to be supplied to the storage capacitor line CS. And the conductive layer 130 may be electrically connected to such a storage capacitor line CS. For example, the storage capacitor signal supplied to the storage capacitor line CS may be equivalent to a counter signal supplied to the counter electrode 142 and the potential in the conductive layer 130 may be as high as the one at the counter electrode 142. In that case, D₁==D₃ is satisfied and neither D₁>D₂>D₃ nor D₁<D₂<D₃ is satisfied. As a result, the alignment is much less disturbed.

Also, in the above description, the pixel electrode 122 is electrically connected to the drain region 126d of the semiconductor layer Se by way of the drain electrode 128. However, the present invention is in no way limited to it. If necessary, the pixel electrode 122 may be directly electrically connected to the drain region 126d of the semiconductor layer Se without passing the drain electrode 128.

Furthermore, in the above description, the pixel electrode 122 is supposed to have a U-shape. However, the present invention is in no way limited to it. The pixel electrode 122 may have an O-shape so that there is an opening between the first and second regions 122a and 122b of the pixel electrode 122.

Moreover, in the above description, the first region 122a of the pixel electrode 122 is supposed to be connected to the second region 122b thereof via the connection region 122c. However, the present invention is in no way limited to it. The pixel electrode 122 may have no connection region 122c so that the first and second regions 122a and 122b are not connected in series together but define first and second subpixel electrodes, respectively. In that case, those two subpixel electrodes may have mutually different potentials. Also, two switching elements may be separately provided for the first and second regions 122a and 122b of the pixel electrode 122. Furthermore, by varying the V-T curves of the subpixels with the potentials at the two subpixels defined to be different from each other, the whitening phenomenon can be suppressed.

Furthermore, in the above description, the liquid crystal molecules 162 are supposed to have a radially tilted alignment around a rivet or an opening. However, the present invention is in no way limited to it. The liquid crystal molecules 162 may be aligned with ribs or slits that are provided for the two substrates 120 and 140 to face the liquid crystal layer 160.

What is more, in the above description, the TFTs 125 and 126 are supposed to have a top gate structure. However, the present invention is in no way limited to it. The TFTs 125 and 126 may have a bottom gate structure as well.

Besides, although the active-matrix substrate 120 is supposed to have storage capacitor lines CS in the above description, the present invention is in no way limited to it. The active-matrix substrate 120 does not have any storage capacitor lines CS.

The entire disclosure of Japanese Patent Application No. 2008-164983, from which the present application claims priority, is hereby incorporated by reference.

### INDUSTRIAL APPLICABILITY

The liquid crystal display device of the present invention can reduce the degree of disturbance of alignment with a decrease in aperture ratio minimized.

### REFERENCE SIGNS LIST

100 liquid crystal display device
120 active-matrix substrate
121 transparent substrate
122 pixel electrode
122a first region
122b second region
124 switching element
125 TFT
126 TIT
128 drain electrode
130 conductive layer
140 counter substrate
141 transparent substrate
142 counter electrode
160 liquid crystal layer
162 liquid crystal molecule

1. A liquid crystal display device comprising:
an active-matrix substrate including a pixel electrode, a gate line, and a source line;
a counter substrate including a counter electrode; and
a liquid crystal layer, which is interposed between the pixel electrode and the counter electrode,
wherein as viewed along a normal to the principal surface of the active-matrix substrate, the pixel electrode has first and second regions, which are respectively arranged on one and the other sides with respect to the gate line, and
wherein the active-matrix substrate further includes a conductive layer, which is arranged in an insulating layer between the gate line and the pixel electrode, and
wherein as viewed along a normal to the principal surface of the active-matrix substrate, the conductive layer has a portion that is located between the first and second regions of the pixel electrode, does overlap the gate line, but is not overlapped by the pixel electrode, and
wherein the conductive layer is electrically connected to either the pixel electrode or the source line.

2. The liquid crystal display device of claim 1, wherein the conductive layer and the source line are made of the same material.

3. The liquid crystal display device of claim 1, wherein the active-matrix substrate further includes:
a semiconductor layer;
a thin-film transistor having the source, channel and drain regions defined in the semiconductor layer; and
a drain electrode, which is electrically connected to the drain region of the thin-film transistor and to the pixel electrode.

4. The liquid crystal display device of claim 3, wherein the drain electrode and the source line are made of the same material.

5. The liquid crystal display device of claim 1, wherein the conductive layer is connected to the source line.

6. The liquid crystal display device of claim 1, wherein the conductive layer is electrically connected to the pixel electrode.

7. The liquid crystal display device of claim 3, wherein the conductive layer is connected to the drain electrode.

8. The liquid crystal display device of claim 1, wherein the pixel electrode further has a connection region that connects the first and second regions together.

9. The liquid crystal display device of claim 1, wherein the first and second regions of the pixel electrode define first and second subpixel electrodes, respectively.

10. The liquid crystal display device of claim 1, wherein the active-matrix substrate further includes a storage capacitor line.

11. A liquid crystal display device comprising:
an active-matrix substrate including a pixel electrode, a gate line, a source line and a storage capacitor line;
a counter substrate including a counter electrode; and
a liquid crystal layer, which is interposed between the pixel electrode and the counter electrode,
wherein as viewed along a normal to the principal surface of the active-matrix substrate, the pixel electrode has first and second regions, which are respectively arranged on one and the other sides with respect to the gate line, and
wherein the active-matrix substrate further includes a conductive layer, which is arranged in an insulating layer between the gate line and the pixel electrode, and
wherein as viewed along a normal to the principal surface of the active-matrix substrate, the conductive layer has a portion that is located between the first and second regions of the pixel electrode, does overlap the gate line, but is not overlapped by the pixel electrode, and
wherein the conductive layer is electrically connected to the pixel electrode, the source line or the storage capacitor line.

12. The liquid crystal display device of claim 11, wherein a potential on the storage capacitor line varies in the same phase with a potential at the counter electrode, and
wherein the conductive layer is electrically connected to the storage capacitor line.
